(19) United States
(12) Patent Application Publication
(10) Pub. No.: US 2013/0039215 A1
(43) Pub. Date: Feb. 14, 2013

(54) System and Method for Direct Multi-User Transmission

(71) Applicants: Osama Aboul-Magd, Kanata (CA); George Calcev, Hoffman Estates, IL (US); Bin Chen, Schaumburg, IL (US)

(72) Inventors: Osama Aboul-Magd, Kanata (CA); George Calcev, Hoffman Estates, IL (US); Bin Chen, Schaumburg, IL (US)

(73) Assignee: FUTUREWEI TECHNOLOGIES, INC., Plano, TX (US)

(21) Appl. No.: 13/546,856

(22) Filed: Jul. 11, 2012

Related U.S. Application Data
(60) Provisional application No. 61/506,984, filed on Jul. 12, 2011.
(60) Provisional application No. 61/508,499, filed on Jul. 15, 2011.

(51) Int. Cl. H04W 8/26; H04W 84/12

(52) U.S. Cl. 370/254

(57) ABSTRACT

A method for transmitting to a plurality of responder stations includes configuring a first responder station for direct link communications, the first responder station being configured with a first group identifier and a first position. The method also includes configuring a second responder station for direct link communications, the second responder station being configured with a second group identifier and a second position. The method further includes transmitting to both the first responder station and the second responder station in a first single transmission, the first single transmission including first information for the first responder station and second information for the second responder station, where the first information is labeled with the first group identifier and located in the first position, and the second information is labeled with the second group identifier and located in the second position.

This application claims the benefit of U.S. Provisional Application No. 61/506,984, filed on Jul. 12, 2011, entitled “System and Method for Multi-User MIMO Communication in Wi-Fi Networks,” and U.S. Provisional Application No. 61/508,499, filed on Jul. 15, 2011, entitled “System and Method for Supporting Multi-User Transmission in WLAN Direct Link Setup,” which applications are hereby incorporated herein by reference.

### TECHNICAL FIELD

The present disclosure relates generally to digital communications, and more particularly to a system and method for direct multi-user transmission.

### BACKGROUND

Wi-Fi is a wireless standard for connecting electronic devices. Wi-Fi may also be known as IEEE 802.11. Generally, a Wi-Fi enabled device (also commonly referred to as a station), such as a personal computer, a tablet, a personal digital assistant, a video game console, a television, a smartphone, a digital media player, and the like may connect to a service provider when it is within range of a Wi-Fi network connected to the service provider. A typical access point (also commonly known as a hotspot) usually has a range on the order of 10 s of meters when indoors and a greater range outdoors. Multiple overlapping access points may be used to provide coverage over larger areas.

### SUMMARY OF THE DISCLOSURE

Example embodiments of the present disclosure which provide a system and method for direct multi-user transmission.

In accordance with an example embodiment of the present disclosure, a method for transmitting to a plurality of responder stations is provided. The method includes configuring, by an initiator station, a first responder station for direct link communications, the first responder station being configured with a first group identifier and a first position. The method also includes configuring, by the initiator station, a second responder station for direct link communications, the second responder station being configured with a second group identifier and a second position. The method further includes transmitting, by the initiator station, to both the first responder station and the second responder station in a first single transmission, the first single transmission includes first information for the first responder station and second information for the second responder station, where the first information is labeled with the first group identifier and located in the first position, and the second information is labeled with the second group identifier and located in the second position.

In accordance with another example embodiment of the present disclosure, a method for receiving a first single transmission is provided. The method includes receiving, by a first responder station, a setup request message including a first group identifier and a first position, and transmitting, by the first responder station, a first setup response message including the first group identifier and the first position if the first group identifier and the first position are not already reserved for use by the first responder station. The method also includes receiving, by the first responder station, the first single transmission including first information for the first responder station and second information for a second responder station, the first information labeled with the first group identifier and located in the first position.

In accordance with another example embodiment of the present disclosure, a method for receiving a first single transmission is provided. The method includes receiving, by a first responder station, a setup request message to configure a direct link communications channel with an initiator station, and receiving, by the first responder station, a first management message including a first group identifier and a first position. The method also includes transmitting, by the first responder station, a first management response message including a positive response if the first group identifier and the first position are not already reserved for use by the first responder station. The method further includes receiving, by the first responder station, the first single transmission including first information for the first responder station and second information for a second responder station, the first information labeled with the first group identifier and located in the first position.

In accordance with another example embodiment of the present disclosure, an initiator station is provided. The initiator station includes a processor, and a transmitter operatively coupled to the processor. The processor sets up a first responder station for direct link communications, the first responder station set up with a first group identifier and a first position, and sets up a second responder station for direct link communications, the second responder station set up with a second group identifier and a second position. The transmitter transmits to both the first responder station and the second responder station in a first single transmission, the first single transmission includes first information for the first responder station and second information for the second responder station, the first information labeled with the first group identifier and located in the first position, and the second information labeled with the second group identifier and located in the second position.

In accordance with another example embodiment of the present disclosure, a first responder station is provided. The first responder station includes a receiver, a transmitter, and a processor operatively coupled to the receiver and to the transmitter. The receiver receives a setup request message including a first group identifier and a first position, and receives a first single transmission including first information for the first responder station and second information for a second responder station, the first information labeled with the first group identifier and located in the first position. The transmitter transmits a first setup response message including the first group identifier and the first position if the first group identifier and the first position are not already reserved for use by the first responder station. The processor determines if the first group identifier and the first position are not already reserved for use by the first responder station.

In accordance with another example embodiment of the present disclosure, a first responder station is provided. The first responder station includes a receiver, a transmitter, and a processor operatively coupled to the receiver and to the transmitter. The receiver receives a setup request message to configure a direct link communications channel with an initiator station, receives a first management message including a first group identifier and a first position, and receives a first single transmission including first information for the first responder station and second information for a second responder station, the first information labeled with the first group identifier and located in the first position. The transmitter transmits a first management response message including a positive response if the first group identifier and the first position are not already reserved for use by the first responder station. The processor determines if the first group identifier and the first position are not already reserved for use by the first responder station.

One advantage of an embodiment is that a single station may directly transmit to multiple other stations without having to transit to an access point, which can reduce latency as well as resource utilization.

A further advantage of an embodiment is that a distributed technique for managing group identifier allocation allows for the management of group identifiers without having to use a centralized management entity.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1a illustrates an example first example communications system according to example embodiments described herein;

FIG. 1b illustrates an example second example communications system according to example embodiments described herein;

FIG. 2a illustrates an example portion of a communications system, where an establishment of a direct link using DLS and/or a TDLS is highlighted according to example embodiments described herein;

FIG. 2b illustrates an example VHT PPDU format according to example embodiments described herein;

FIG. 2c illustrates an example message exchange between network entities involved in a TDLS link establishment according to example embodiments described herein;

FIG. 3 illustrates an example preamble with built-in support for MU-MIMO according to example embodiments described herein;

FIG. 4 illustrates an example frame with built-in support for group identifier management according to example embodiments described herein;

FIG. 5 illustrates an example information element according to example embodiments described herein;

FIG. 6 illustrates an example TDLS transmission frame according to example embodiments described herein;

FIG. 7 illustrates an example communications system wherein a first example configuration of TDLS direct links is highlighted according to example embodiments described herein;

FIG. 8 illustrates an example communications system wherein a second example configuration of TDLS direct links is highlighted according to example embodiments described herein;

FIG. 9a illustrates a first example flow diagram of operations occurring in an initiator station as the initiator station transmits to a plurality of responder stations according to example embodiments described herein;

FIG. 9b illustrates a second example flow diagram of operations occurring in an initiator station as the initiator station transmits to a plurality of responder stations according to example embodiments described herein;

FIG. 10a illustrates a first example flow diagram of operations occurring in a responder station as the responder station participates in setting up a TDLS direct link and receives a transmission from an initiator station over the TDLS direct link according to example embodiments described herein;

FIG. 10b illustrates a second example flow diagram of operations occurring in a responder station as the responder station participates in setting up a TDLS direct link and receives a transmission from an initiator station over the TDLS direct link according to example embodiments described herein;

FIG. 11 illustrates an example flow diagram of operations occurring in an AP as the AP receives and transmits transmissions in establishing a TDLS direct link according to example embodiments described herein;

FIG. 12 illustrates an example first communications device according to example embodiments described herein; and

FIG. 13 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to direct multi-user transmission. For example, an initiating station configures a first responder station and a second responder station for direct multi-user transmission by transmitting setup request messages to them. The setup request messages include group identifier information and position information for the two responder stations. The initiating station transmits to both the first responder station and the second responder station in a single message with information intended for two responder stations labeled by their respective group identifiers and in locations according to their respective position information. For example, a first responder station receives a setup request message that includes group identifier information and location information for the first responder station. The first responder station replies with a setup response message that includes the group identifier information and the location information if the group identifier information and the location information are not already reserved. The first responder station receives a single transmission that includes information intended for it, as well as information intended for a second responder station. The information intended for the first responder station is labeled with the group identifier information and located in the position.

The present disclosure will be described with respect to example embodiments in a specific context, namely an IEEE 802.11 compliant communications system that supports multi-user communications. The disclosure may also be applied, however, to other standards compliant and non-standards compliant communications systems that support multi-user communications.

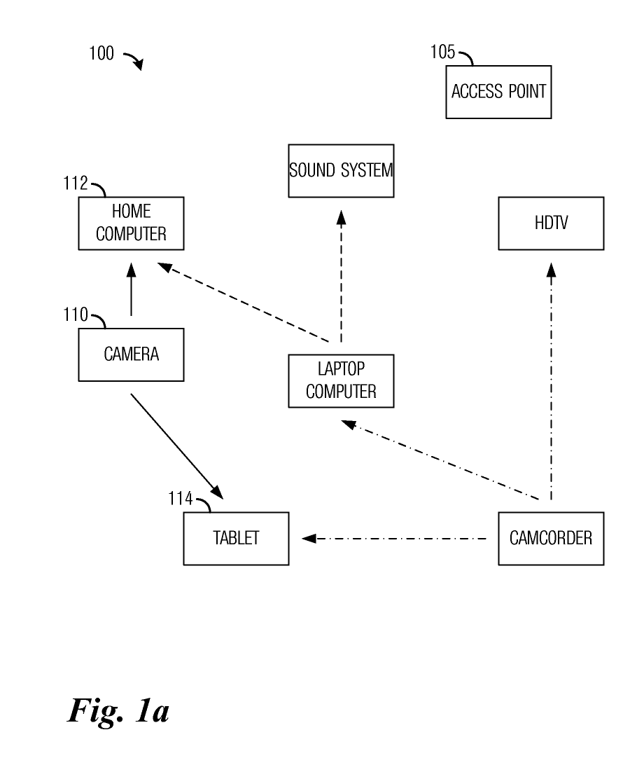

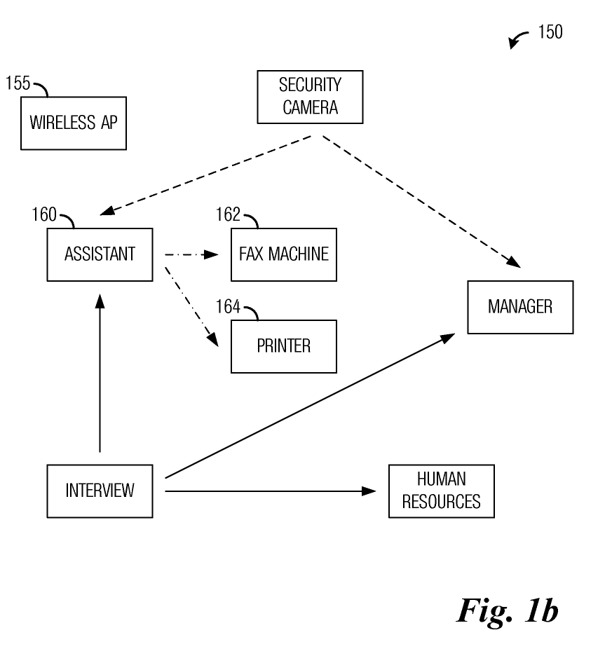

FIG. 1a illustrates a first example communications system 100. Communications system 100 may include a plurality of Wi-Fi enabled devices, also commonly referred to as stations or STA, that are capable of communicating with one another through an access point (AP) 105. Typically, a first station, such as a camera 110 may communicate with a second station, such as a home computer 112, and/or a third station, such as a tablet 114, by transmitting to AP 105, which in turn transmits to the second station or the third station. It is noted that the transmission to AP 105 and from AP 105 are not shown in FIG. 1a.

FIG. 1b illustrates a second example communications system 150. Communications system 150 may include a plurality of stations that are capable of communicating with one another through an AP 155. As an example, a computer used by assistant 160 may communicate with a fax machine 162 and a printer 164. It is noted that the transmission to AP 155 and from AP 155 are not shown in FIG. 1b.

In general, communicating through an AP, such as AP 105 and AP 155, adds additional messaging latency due to the extra transmission. In other words, the extra transmission between the first station and the AP and then from the AP to the second station, for example, may increase the messaging latency when compared to a direct transmission between the first station and the second station. Therefore, for some forms of communications, such as latency sensitive communications, high data throughput communications, and the like, the extra messaging latency may negatively impact the performance.

Direct Link Setup (DLS) and Tunnel DLS (TDLS) are two IEEE 802.11 protocols that allow a station (referred to as an initiator station or initiator STA) to establish a direct link between itself and another station (referred to as a responder station or responder STA). In DLS and TDLS, the initiator station establishes the direct link with the responder station by transmitting to the responder station through an AP.

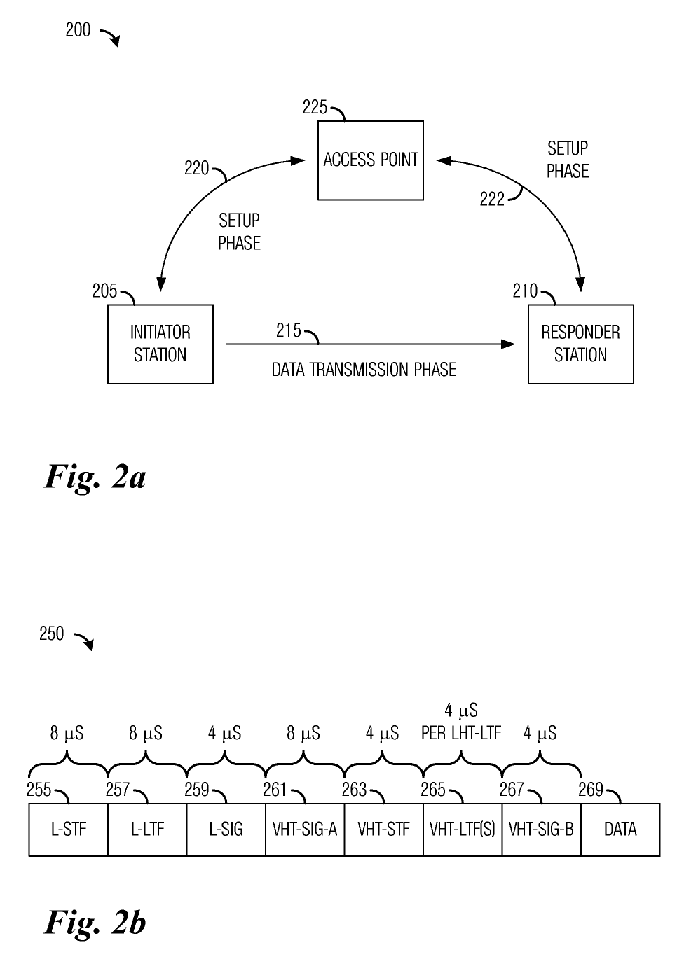

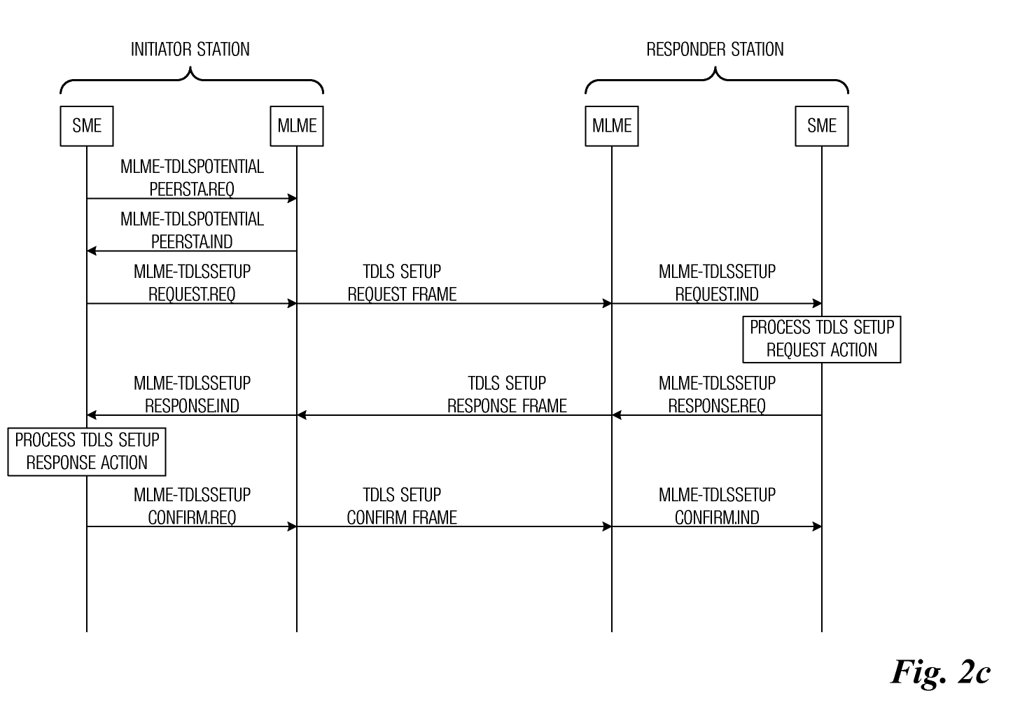

FIG. 2a illustrates a portion of a communications system 200, where an establishment of a direct link using DLS and/or a TDLS is highlighted. Communications system 200 includes an initiator station 205 and a responder station 210. Initiator station 205 is to transmit information, such as data, media, and the like, to responder station 210 through a direct link 215.

Establishing direct link 215 between initiator station 205 and responder station 210 includes a setup phase that may include an exchange of control information (using transmissions 220 and 222, for example) to configure direct link 215. In the setup phase, the control information exchanged between initiator station 205 and responder station 210 flows through an AP 225. In other words, in order to transmit the control information to responder station 210, initiator station 205 transmits the control information to AP 225, which then transmits the control information to responder station 210, and vice versa.

FIG. 2b illustrates an example very high throughput (VHT) protocol data unit (PPDU) format 250. VHT PPDU includes a legacy short training field (L-STF) 255, a legacy long training field (L-LTF) 257, a legacy signal (L-SIG) field 259, a VHT signal A (VHT-SIG-A) field 261, a VHT short training field (VHT-STF) 263, one or more VHT long training fields (VHT-LTF) 265, a VHT signal B (VHT-SIG-B) field 267, and a data field 269. FIG. 2c illustrates a message exchange between entities involved in a TDLS link establishment. As shown in FIG. 2c, the message exchange involves messages exchanged between an initiator station and a responder station (which is also commonly referred to as a peer station), and entities within the two stations, including a station management entity (SME) and a MAC sublayer management entity (MLME). Referring back now to FIG. 2a, with direct link 215 is established in the setup phase, initiator 205 may use it to transmit to responder 210 in a data transmission phase.

As an example, in TDLS control information transmitted in action management frames may be used to set up a direct link between two stations. The action frames may be used in a discovery phase where an initiator station may discover a responder station to which it is to communicate. The action frames may also be used in a TDLS Setup Request message used by the initiator station to configure the responder station, a TDLS Setup Response message used by the responder station to respond to the TDLS Setup Request message from the initiator station, a TDLS Confirm message that confirms the establishment of the direct link, and a TDLS Teardown message used by the initiator station to tear down the direct link.

Once the direct link is established, transmissions over the direct link may be labeled to identify them from other transmissions, such as transmissions to an AP or from an AP. As an example, TDLS data frames may be identified by setting flags “ToDS” and “FromDS” to specific values, e.g., binary 0. Table 1 illustrates possible values for flags ToDS and FromDS and example meanings of the flags.

TABLE 1
ToDS and FromDS values and meanings.

| TO DS AND | |
|---|---|
| FROM DS VALUES | MEANING |
| TO DS = 0 | A data frame direct from one station to another |
| FROM DS = 0 | station within the same Independent Basic |
| | Service Set (IBSS), a data frame direct from |
| | one station to another station within the same |
| | Basic Service Set (BSS), or a data frame |
| | outside the context of a BSS, as well as all |
| | management and control frames |
| TO DS = 1 | A data frame destined for the Distribution |
| FROM DS = 0 | System (DS) or being sent by a station |
| | associated with an AP to the Port access entity |
| | in that AP |
| TO DS = 0 | A data frame exiting the DS or being sent by |
| FROM DS = 1 | the port access entity in an AP |
| TO DS = 1 | A data frame using the four-address format. |
| FROM DS = 1 | This standard does not define procedures for |
| | using this combination of field values |

Multi-user multiple input, multiple output (MU-MIMO) allows a single device, such as an AP or a station, to transmit multiple independent spatial streams using multiple transmit antennas. In general, in a device with N transmit antennas, up to N independent spatial streams may be transmitted with each of the N transmit antennas being used to transmit one independent spatial stream, where N is a positive integer value. The N independent spatial streams may be directed to a single device or multiple devices.

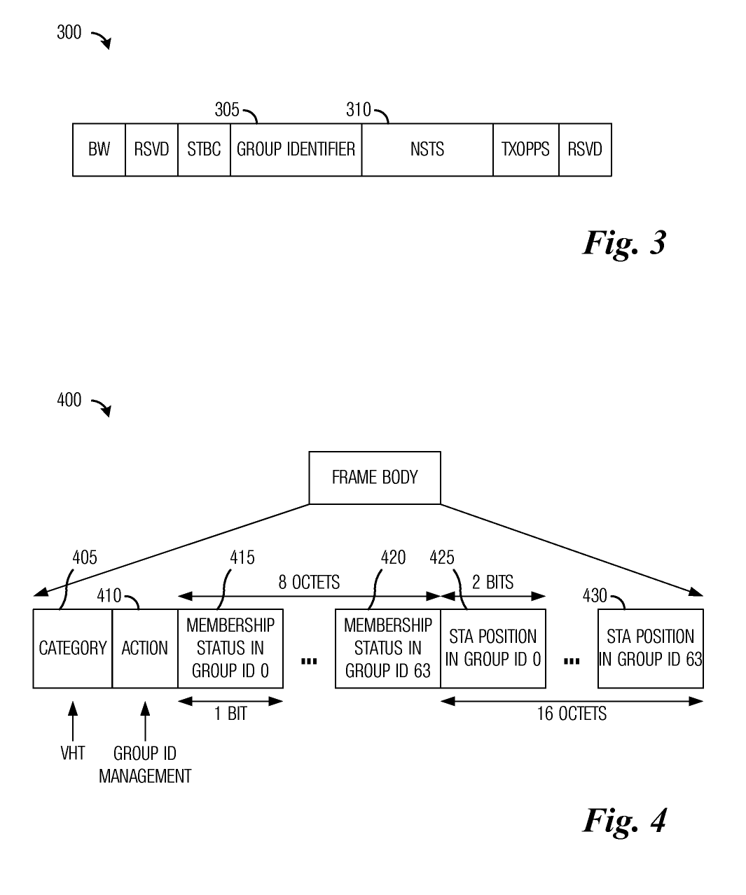

FIG. 3 illustrates a preamble 300 with built-in support for MU-MIMO. As shown in FIG. 3, preamble 300 includes fields for supporting MU-MIMO. The fields used for supporting MU-MIMO include a group identifier field 305 and a number of spatial streams (NSTS) field 310. As an example, in a IEEE 802.11ac very high throughput (VHT) preamble, group identifier field 305 may be a 6-bit field that is sufficient to identify up to 64 groups (e.g., by a group identifier). The group identifier may define group membership, as well as order in downlink multi-user transmission. It is noted that group identifier zero (0) is reserved for station to AP transmission, while group identifier 63 is reserved for downlink single user transmissions. NSTS field 310 may be representative of a number of independent spatial streams for each member station of a particular group identifier. As an example, NSTS field 310 may indicate a number of independent spatial streams for each member station of a group identified in group identifier field 305.

Generally, one or two bits may be sufficient for NSTS field 310, however, a larger number of bits may be used in a situation where a large number of independent spatial streams is assigned to each member station. It is noted that if there are multiple groups of stations, there may be multiple group identifier fields and multiple NSTS fields. The multiple group identifier fields and multiple NSTS fields may be transmitted in separate preambles, combined in a single preamble, or a combination thereof.

FIG. 4 illustrates a frame 400 with built-in support for group identifier management. As shown in FIG. 4, frame 400 may be used to manage group identifiers in a Basic Service Set (BSS). Frame 400 may be transmitted to a single station to indicate the station's membership in specific groups. In addition to indicating which groups the station belongs to, frame 400 may indicate the station's position in each of the groups.

As an example, in IEEE 802.11ac, group identifier management may be included in a group identifier management frame. Frame 400 may include a category field 405 that indicates a frame category, such as VHT. Frame 400 may also include an action field 410 that indicates a frame type, such as group identifier management.

Frame 400 also includes a plurality of group identifier membership status fields, such as membership status field 415 and membership status field 420. As an example, each membership status field may be a single bit in length, therefore, for the 64 possible group identifiers, the plurality of group identifier membership status fields may occupy a total of 8 octets (bytes).

Frame 400 also includes a plurality of station position fields, such as station position field 425 and station position field 430. As an example, each group may include up to four stations, one station per position. Hence, two bits may be sufficient to represent the possible position of a station within a group. With two bits per station position field, the plurality of station position fields may occupy a total of 16 octets or bytes.

As an illustrative example, considering a situation where a station is a member of groups having group identifiers 1, 4, and 10, with positions 0, 0, and 3 within the respective groups, then a frame transmitted to the station may have bits of membership status fields of group identifiers 1, 4, and 10 set to a binary 1 and bits of station position fields corresponding to the group identifiers set to binary 00, 00, and 11, respectively.

It may be possible to extend a direct link to allow an initiator station to simultaneously transmit to multiple responder stations by using MU-MIMO. Such a link may be referred to as a TDLS direct link. It is noted that DLS as well as other protocols may be used to support a direct link that allows an initiator station to simultaneously transmit to multiple responder stations. Without loss of generality, direct links configured using DLS and the other protocols may also be referred to as TDLS direct links. The N transmit antennas combined with a direct link may allow for simultaneous transmissions to up to N responder stations. It is noted that if multiple independent spatial streams are sent to a single responder station, the number of responder stations receiving the N independent spatial streams will be smaller than N.

An information element may be added to TDLS messages (as well as DLS messages and other protocols that may be used to configure direct links) to enable the management (e.g., configuration and tear down) of direct links between an initiator station and one or more responder stations that will be utilizing the direct links. The information element may be added to TDLS Setup Request messages, TDLS Setup Response messages, TDLS Confirm messages, TDLS Teardown messages, and the like, to manage direct links. It is noted that the information element may be added to DLS messages, as well as messages of other protocols that are used to manage direct links.

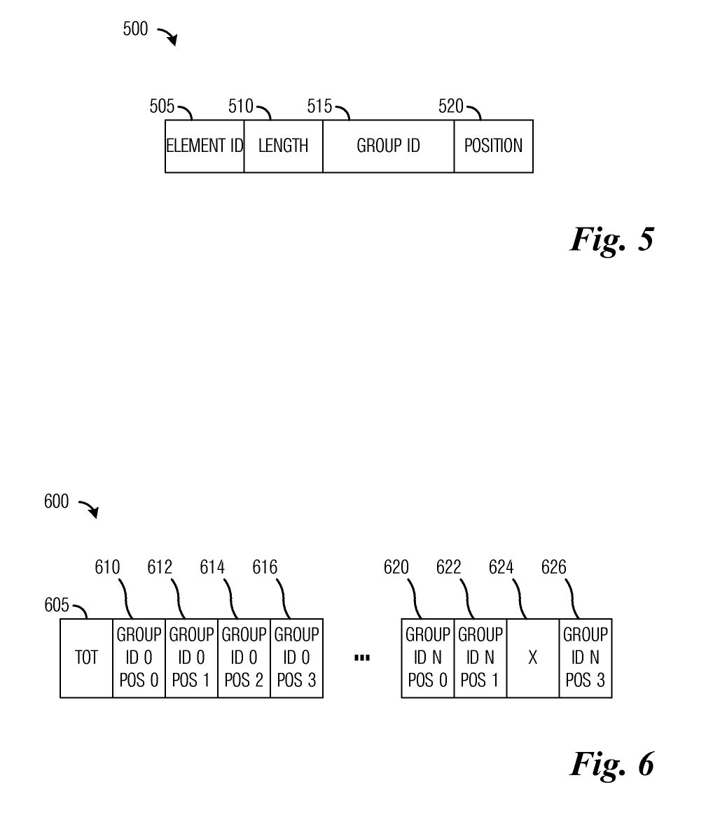

FIG. 5 illustrates an information element 500. Information element 500 may include an element identifier 505 that is used to distinguish information element 500 from other types of information elements. It is noted that multiple instances of information element 500 may have the same value in its element identifier 505. Information element 500 may also include a length 510 that indicates a number of information elements comprising information element 500. As an example, length 510 may be set to 1, indicating that information element 500 comprises a single information element.

Information element 500 may also include a group identifier 515 that indicates a group identifier for a responder station and a position 520 that indicates a position within a group corresponding to the group identifier for the responder station. It is noted that for IEEE 802.11ac compliant communications systems, group identifier 515 may be a 6-bit value to accommodate the 64 possible group identifiers, and position 520 may be a 2-bit value to accommodate the four possible positions within a single group. As an example, in a TDLS Setup Request message, group identifier 515 may include a proposed group identifier for the responder station and position 520 may include a proposed position in a group corresponding to the proposed group identifier. Similarly, in a TDLS Setup Response message, group identifier 515 may include a proposed group identifier for the responder station and position 520 may include a proposed position in a group corresponding to the proposed group identifier, as in a TDLS Setup Request message. However, it may be possible that in a TDLS Setup Response message, group identifier 515 may include an alternate group identifier for the responder station and position 520 may include an alternate position in a group corresponding to the alternate group identifier.

FIG. 6 illustrates a TDLS transmission frame 600. TDLS transmission frame 600 may be transmitted by an initiator station to a plurality of responder stations. TDLS transmission frame 600 may include a Type of Transmission (TOT) field 605 to indicate transmission type, e.g., a downlink MU-MIMO transmission from an AP to multiple stations or a TDLS MU-MIMO direct link transmission from an initiator station to multiple responder stations. For example, TOT field 605 may be a 1-bit field. It is noted that strictly speaking, TOT field 605 may not be required due to the use of ToDS and FromDS bits to distinguish TDLS frames at a media access control (MAC) layer. However, the inclusion of TOT field 605 provides advantages such as faster recognition of the transmission type at a physical (PHY) layer, and stations not engaged in TDLS communications may be able to enter power savings mode when detecting messages with TOT fields set to indicate TDLS MU-MIMO direct link transmissions. Additionally, TOT field 605 may be extended to indicate other transmission types with the addition of extra bits, such as mesh transmission, and the like. The management of group identifier for TDLS direct link transmissions and normal transmissions may be achieved with different management processes, determined by the value of TOT field 605.

According to an alternative example embodiment, one or more bits in VHT-SIG-A field, such as VHT-SIG-A field 261, of a VHT PPDU may be used to distinguish between AP and station originator of a TDLS transmission. As an example, if the one or more bits in the VHT-SIG-A field is set to a first value, then the AP may be the originator of the TDLS transmission, while if the one or more bits in the VHT-SIG-A field is set to a second value, then the station may be the originator of the TDLS transmission. As an example, bits 13-21 of a VHT PPDU may contain one or more bits to distinguish between AP and/or station originator of a TDLS transmission.

According to another alternative example embodiment, an originator address and a group identifier may be used to determine the source of a station originator of a TDLS transmission. As an example, target destinations of the TDLS transmission associate the group identifier with a base station identifier and the originator address to distinguish between multiple TDLS transmissions. The association between the group identifier and the base station identifier and the originator address may be retained for as long as the TDLS link remains active.

TDLS transmission frame 600 may also include information intended for the various responder stations participating in TDLS direct link operation. As shown in FIG. 6, the information intended for the various responder stations may be organized by group identifier and position. As an example, consider a situation wherein there are four responder stations for a group corresponding to group identifier zero (0). Then, the information for each of the four responder stations may be transmitted in network resources, such as time slots, frequency slots, or time-frequency slots, corresponding positions 0, 1, 2, and 3 (shown as blocks 610, 612, 614, and 616). As another example, consider a situation wherein there are three responder stations for a group corresponding to group identifier N with the responder stations located in positions 0, 1, and 3. Then, the information for each of the three responder may be transmitted in network resources, such as time slots, frequency slots, or time-frequency slots, corresponding positions 0, 1, and 3 (shown as blocks 620, 622, and 626).

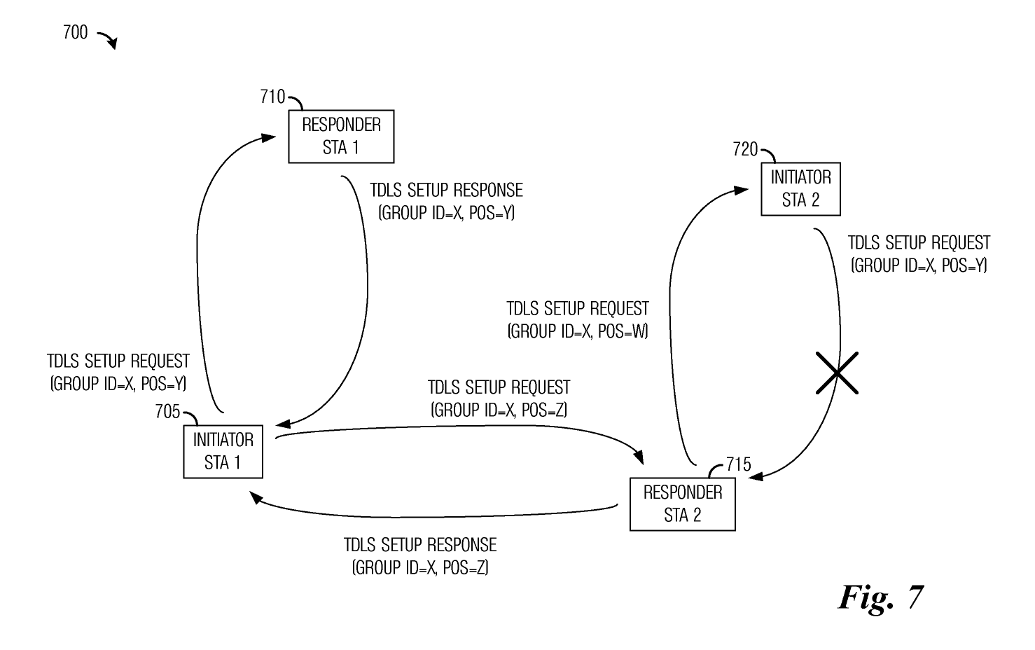

FIG. 7 illustrates a communications system 700 wherein a first example configuration of TDLS direct links is highlighted. Communications system 700 includes a first initiator station (INITIATOR STA 1) 705, a first responder station (RESPONDER STA 1) 710, a second responder station (RESPONDER STA 2) 715, and a second initiator station (INITIATOR STA 2) 720, with first initiator station 705 attempting to configure a TDLS direct link with first responder station 710 and second responder station 715 and second initiator station 720 attempting to configure a TDLS direct link with second responder station 715. It is noted that the initiator stations (i.e., first initiator station 705 and second initiator station 720) may also have TDLS direct links with other responder stations not shown in FIG. 7. It is also noted that communications system 700, as shown in FIG. 7, does not include an AP. However, the messages sent in establishing a TDLS direct link are actually sent through an AP. Regardless, the AP and messages sent to and from the AP are omitted to maintain simplicity in FIG. 7.

First initiator station 705 may begin by transmitting a TDLS Setup Request message to first responder station 710 with an information element, such as information element 500, including group identifier X and position Y. For discussion purposes, consider a situation wherein first responder station 710 accepts group identifier X and position Y. First responder station 710 may send a TDLS Setup Response message to first initiator station 705 with an information element including group identifier X and position Y. First responder station 710 may now be configured for TDLS direct link operation with first initiator station 705.

First initiator station 705 may begin by transmitting a TDLS Setup Request message to second responder station 715 with an information element including group identifier X and position Z. It is noted that the group identifier for second responder station 715 does not necessarily need to be the same as the group identifier for first responder station 710. For discussion purposes, consider a situation wherein second responder station 715 accepts group identifier X and position Z. Second responder station 715 may send a TDLS Setup Response message to first initiator station 705 with an information element including group identifier X position Z. Second responder station 715 may now be configured for TDLS direct link operation with first initiator station 705.

Second initiator station 720 may transmit a TDLS Setup Request message to second responder station 715 with an information element including group identifier X and position Y. It is noted that the group identifier for second responder station 715 does not necessarily need to be the same as the group identifier for first responder station 710. For discussion purpose, considering a situation wherein second responder station 715 has already accepted group identifier X and position Y with first initiator station 705. Hence, there is a conflict in group identifiers (i.e., X) and position (i.e., Y). Therefore, second responder station 715 may not be able to distinguish transmissions from first initiator station 705 and second initiator station 720 associated with group identifier X and position Y. Second responder station 715 may then reject the proposed group identifier X and position Y. Instead, second responder station 715 selects an alternative group identifier X and alternative position W. It is noted that the alternative group identifier does not need to be the same as the group identifier proposed by second initiator station 720, nor does the alternative position.

If second initiator station 720 accepts the alternative group identifier and the alternative position, then the second responder station 715 may now be configured for TDLS direct link operation with second initiator station 720. If second initiator station 720 does not accept the alternative group identifier and the alternative position, then second initiator station 720 may select another group identifier and another position and transmit another TDLS Setup Request message to second responder station 715. The TDLS Setup Request message and the TDLS Setup Response message pair may continue until the TDLS direct link is setup or second initiator station 720 stops attempting to configure second responder station 715.

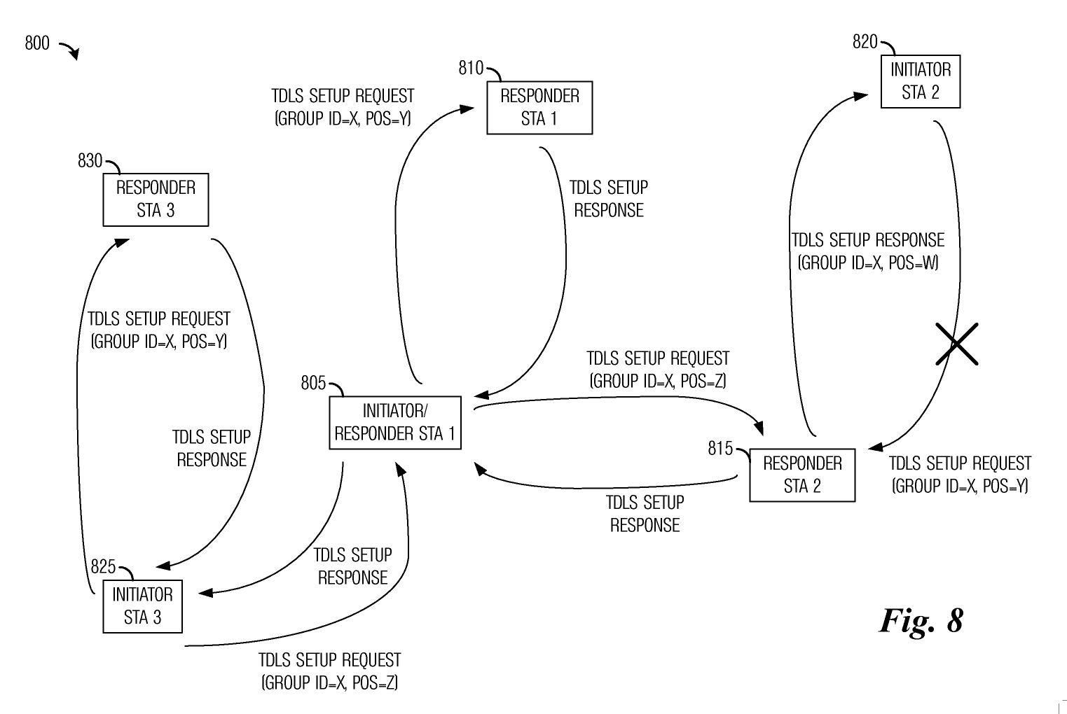

FIG. 8 illustrates a communications system 800 wherein a second example configuration of TDLS direct links is highlighted. Communications system 800 includes a first initiator/responder station (INITIATOR/RESPONDER STA 1) 805, a first responder station (RESPONDER STA 1) 810, a second responder station (RESPONDER STA 2) 815, a second initiator station (INITIATOR STA 2) 820, a third initiator station (INITIATOR STA 3) 825, and a third responder station (RESPONDER STA 3) 830, with first initiator/responder station 805 attempting to configure a TDLS direct link with first responder station 810 and second responder station 815, second initiator station 820 attempting to configure a TDLS direct link with second responder station 815, and third initiator station 825 attempting to configure a TDLS direct link with third responder station 830 and first initiator/responder station 805. It is noted that the initiator stations (i.e., first initiator/responder station 805, second initiator station 820, and third initiator station 825) may also have TDLS direct links with other responder stations not shown in FIG. 8. It is noted that the TDLS Setup Response messages shown in FIG. 8 do not include the contents of the information element. It is also noted that communications system 800, as shown in FIG. 8, does not include an AP. However, the messages sent in establishing a TDLS direct link are actually sent through an AP. Regardless, the AP and messages sent to and from the AP are omitted to maintain simplicity in FIG. 8.

First initiator/responder station 805 may begin by transmitting a TDLS Setup Request message to first responder station 810 with an information element including group identifier X and position Y. For discussion purposes, consider a situation wherein first responder station 810 accepts group identifier X and position Y. First responder station 810 may send a TDLS Setup Response message to first initiator/responder station 805 with an information element including group identifier X and position Y. First responder station 810 may now be configured for TDLS direct link operation with first initiator/responder station 805.

First initiator/responder station 805 may begin by transmitting a TDLS Setup Request message to second responder station 815 with an information element including group identifier X and position Z. It is noted that the group identifier for second responder station 815 does not necessarily need to be the same as the group identifier for first responder station 810. For discussion purposes, consider a situation wherein second responder station 815 accepts group identifier X and position Z. Second responder station 815 may send a TDLS Setup Response message to first initiator/responder station 805 with an information element including group identifier X and position Z. Second responder station 815 may now be configured for TDLS direct link operation with first initiator/responder station 805.

Second initiator station 820 may transmit a TDLS Setup Request message to second responder station 815 with an information element including group identifier X and position Y. It is noted that the group identifier for second responder station 815 does not necessarily need to be the same as the group identifier for first responder station 810. For discussion purposes, consider a situation wherein second responder station 815 has already accepted group identifier X and position Y with first initiator/responder station 805. Hence, there is a conflict in group identifiers (i.e., X) and position (i.e., Y). Therefore, second responder station 815 may not be able to distinguish transmissions from first initiator/responder station 805 and second initiator station 820 associated with group identifier X and position Y. Second responder station 815 may then reject the proposed group identifier X and position Y. Instead, second responder station 815 selects an alternative group identifier X and alternative position W. It is noted that the alternative group identifier does not need to be the same as the group identifier proposed by second initiator station 820, nor does the alternative position.

If second initiator station 820 accepts the alternative group identifier and the alternative position, then the second responder station 815 may now be configured for TDLS direct link operation with second initiator station 820. If second initiator station 820 does not accept the alternative group identifier and the alternative position, then second initiator station 820 may select another group identifier and another position and transmit another TDLS Setup Request message to second responder station 815. The TDLS Setup Request message and the TDLS Setup Response message pair may continue until the TDLS direct link is setup or second initiator station 820 stops attempting to configure second responder station 815.

Third initiator station 825 may transmit a TDLS Setup Request message to third responder station 830 with an information element including group identifier X and position Y. For discussion purposes, consider a situation wherein third responder station 830 accepts group identifier X and position Y. It is noted that although communications system 800 already includes another TDLS direct link with the same group identifier and position (between first initiator/responder station 805 and first responder station 810), the initiator stations and/or the responder stations involved in the two TDLS direct links are disjointed, so there is no conflict in using the same group identifier and/or position. Third responder station 830 may send a TDLS Setup Response message to third initiator station 825 with an information element including group identifier X and position Y. Third responder station 830 may now be configured for TDLS direct link operation with third initiator station 825.

Third initiator station 825 may transmit a TDLS Setup Request message to first initiator/responder station 805 with an information element including group identifier X and position Z. For discussion purposes, consider a situation wherein first initiator/responder station 805 accepts group identifier X and position Z. It is noted that although communications system 800 already includes another TDLS direct link with the same group identifier and position (between first initiator/responder station 805 and second responder station 815), the initiator stations and/or the responder stations involved in the two TDLS direct links are disjointed, so there is no conflict in using the same group identifier and/or position. First initiator/responder station 805 may send a TDLS Setup Response message to third initiator station 825 with an information element including group identifier X and position Z. First initiator/responder station 805 may now be configured for TDLS direct link operation with third initiator station 825.

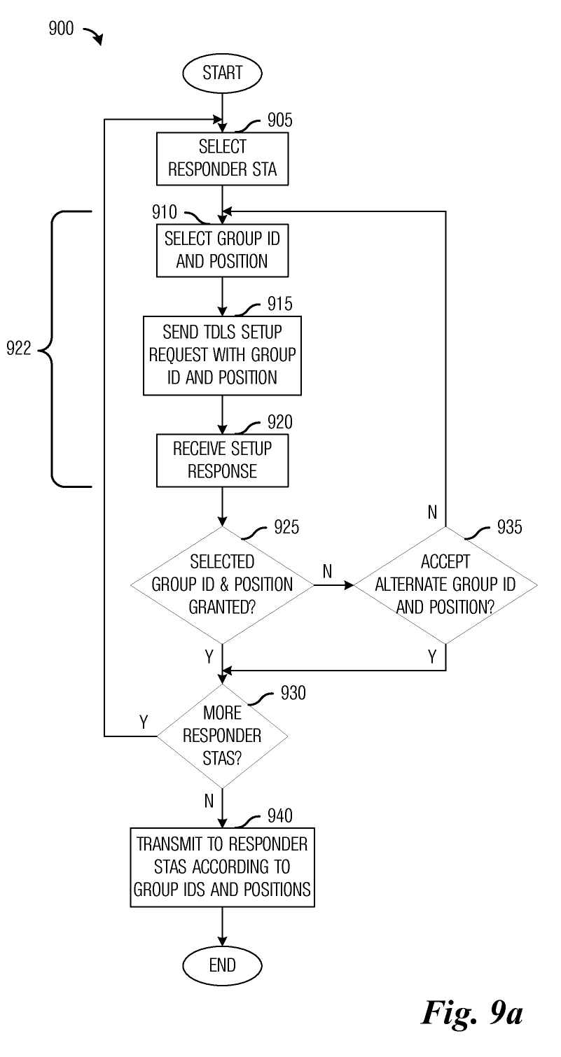

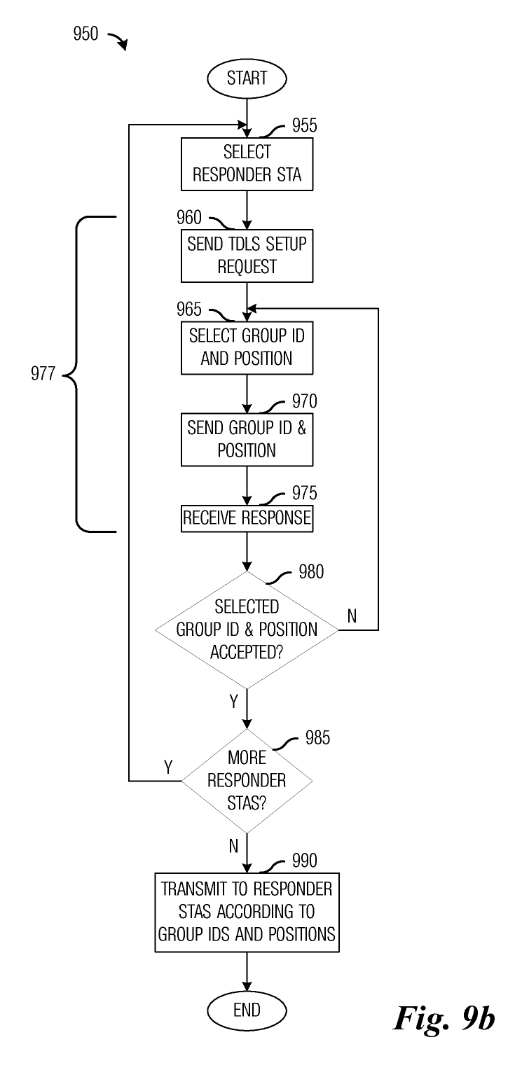

FIG. 9a illustrates a first flow diagram of operations 900 occurring in an initiator station as the initiator station transmits to a plurality of responder stations. Operations 900 may be indicative of operations occurring in an initiator station, such as first initiator station 705 and second initiator station 720 of FIG. 7, as the initiator stations transmit to a plurality of responder stations.

Operations 900 may begin with the initiator station selecting a responder station (block 905). In general, the TDLS direct link permits the initiator station to simultaneously transmit to a plurality responder stations. However, the initiator station may need to configure the responder stations one at a time. As an example, the initiator station may randomly select the responder station from the plurality of responder stations. As another example, the initiator station may select the responder station in order of a ranking of the plurality of responder stations, such as amount of information to send to the responder stations, responder station priority, information priority, quality of service restrictions, and the like.

The initiator station may select a group identifier and a position for the selected responder station (block 910). The initiator station may select the group identifier and the position for the selected responder station according to selection criteria such as available group identifiers, available positions, previously selected group identifiers, previously selected positions, conflicting group identifiers, conflicting positions, and the like. As an example, if there is a previously selected group identifier with one or more available positions, the initiator station may select the same group identifier and one of the available positions for the selected responder station. As another example, if the initiator station intends to include 4 or fewer responder stations in the TDLS direct link, the initiator station may elect to select a single group identifier for all of the responder stations in order to simplify group identifier management.

The initiator station may transmit a TDLS Setup Request message to the selected responder station with an information element that includes the selected group identifier and the selected position (block 915). As discussed previously, the TDLS Setup Request message may be sent to the responder station by way of an AP. The initiator station may receive a TDLS Setup Response message with an information element that includes a response group identifier and a response position (block 920). As discussed previously, the TDLS Setup Response message may be sent from the responder station by way of the AP. Collectively, blocks 910, 915, and 920 may be referred to as configuring (or setting up) responder stations (shown as highlight 922), which may occur during a setup phase as shown in FIG. 2a.

The initiator station may perform a check to determine if the selected group identifier and the selected position were accepted (block 925). The selected group identifier and the selected position were accepted if the selected group identifier and the selected position are equal to the response group identifier and the response position. If the selected group identifier and the selected position were accepted, then the initiator station may perform a check to determine if there are any more responder stations (i.e., all of the responder stations in the plurality of responder stations have been configured) (block 930). If there are more responder stations, then the initiator station may return to block 905 to select another responder station. If there are no more responder stations, then the TDLS direct link may be configured and the initiator station may use the TDLS direct link and the group identifiers and positions of the plurality of responder stations to simultaneously transmit to the plurality of responder stations (block 940).

However, if the selected group identifier and/or the selected position are not equal to the response group identifier and/or the response position, then the selected group identifier and/or the selected position were not accepted, then the initiator station may perform a check to determine if it will accept the response group identifier and the response position (block 935). If the initiator station accepts the response group identifier and the response position, then the initiator station may move to block 930 to perform a check to determine if there are more responder stations. If the initiator station does not accept the response group identifier and the response position, then the initiator station may move to block 910 to select another group identifier and/or position to configure the selected responder station.

FIG. 9b illustrates a second flow diagram of operations 950 occurring in an initiator station as the initiator station transmits to a plurality of responder stations. Operations 950 may be indicative of operations occurring in an initiator station, such as first initiator station 705 and second initiator station 720 of FIG. 7, as the initiator stations transmit to a plurality of responder stations.

Operations 950 may begin with the initiator station selecting a responder station (block 955). In general, the TDLS direct link permits the initiator station to simultaneously transmit to a plurality responder stations. However, the initiator station may need to configure the responder stations one at a time. As an example, the initiator station may randomly select the responder station from the plurality of responder stations. As another example, the initiator station may select the responder station in order of a ranking of the plurality of responder stations, such as amount of information to send to the responder stations, responder station priority, information priority, quality of service restrictions, and the like.

The initiator station may transmit a TDLS Setup Request message to the selected responder station to configure the TDLS link (block 960). The TDLS Setup Request message may establish the TDLS link between the initiator station and the selected responder station. As discussed previously, the TDLS Setup Request message may be sent to the responder station by way of an AP.

The initiator station may select a group identifier and a position for the selected responder station (block 965). The initiator station may select the group identifier and the position for the selected responder station according to selection criteria such as available group identifiers, available positions, previously selected group identifiers, previously selected positions, conflicting group identifiers, conflicting positions, and the like. As an example, if there is a previously selected group identifier with one or more available positions, the initiator station may select the same group identifier and one of the available positions for the selected responder station. As another example, if the initiator station intends to include 4 or fewer responder stations in the TDLS direct link, the initiator station may elect to select a single group identifier for all of the responder stations in order to simplify group identifier management.

The initiator station may send the group identifier and the position to the selected responder station in a frame, e.g., a TDLS Group ID Management frame (block 970). The frame may be similar to group management frames transmitted by an AP. According to an example embodiment, the frame may be sent in a message separate from the TDLS Setup Request message. According to an alternative example embodiment, the frame may be sent in a piggyback manner with the TDLS Setup Request message sent in block 960 or in a subsequent TDLS Setup Request message addressed to a different responder station or in some other TDLS message.

The initiator station may receive a response message (block 975). The response message may be in response to the TDLS Setup Request message and/or the frame. Collectively, blocks 960, 965, 970, and 975 may be referred to as configuring (or setting up) responder stations (shown as highlight 977), which may occur during a setup phase as shown in FIG. 2a.

The initiator station may perform a check to determine if the selected group identifier and the selected position were accepted (block 980). As an example, the selected group identifier and the selected position were accepted if the responsive message included a positive or affirmative response. As another example, the selected group identifier and the selected position were accepted if the selected group identifier and the selected position are equal to the response group identifier and the response position included in the response message. If the selected group identifier and the selected position were accepted, then the initiator station may perform a check to determine if there are any more responder stations (i.e., all of the responder stations in the plurality of responder stations have been configured) (block 985). If there are more responder stations, then the initiator station may return to block 955 to select another responder station. If there are no more responder stations, then the TDLS direct link may be configured and the initiator station may use the TDLS direct link and the group identifiers and positions of the plurality of responder stations to simultaneously transmit to the plurality of responder stations (block 990).

However, if the response message included a negative response or if the selected group identifier and/or the selected position are not equal to the response group identifier and/or the response position included in the response message, then the initiator station may return to block 965 to select another group identifier and/or position. The initiator station may repeat the selection of the group identifier and/or the position until the selected responder station accepts a group identifier and position or until a failure mechanism (e.g., a timer times out or a counter reaches a specified number of trials) is met. With the failure mechanism met, the initiator station may select another responder station or terminate the configuration of the responder stations if there are no other responder stations.

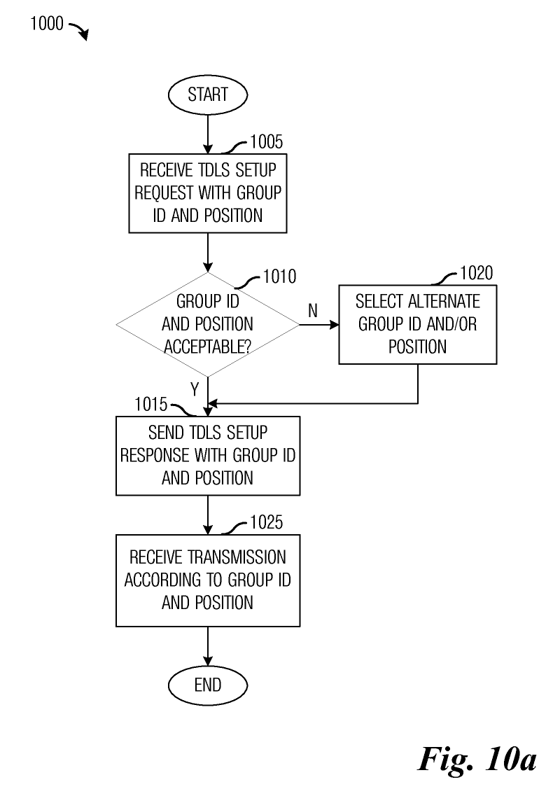

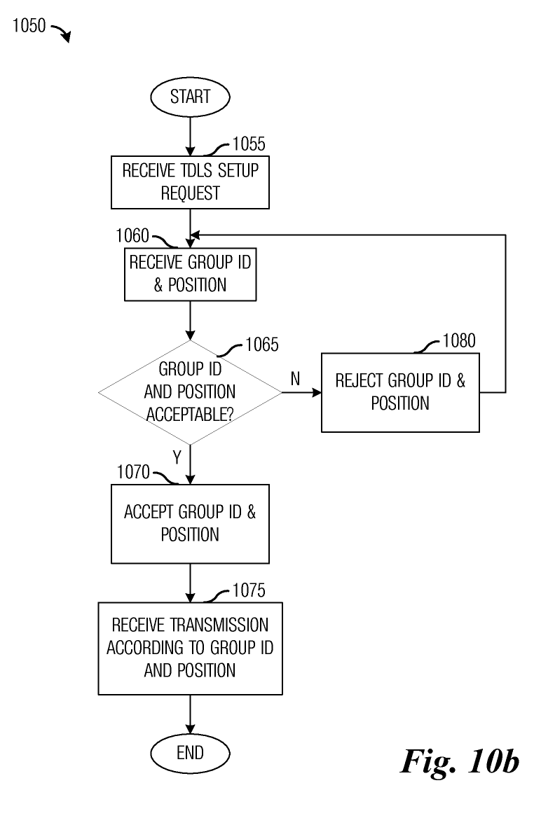

FIG. 10a illustrates a first flow diagram of operations 1000 occurring in a responder station as the responder station participates in setting up a TDLS direct link and receives a transmission from an initiator station over the TDLS direct link. Operations 1000 may be indicative of operations occurring in a responder station, such as first responder station 710 and second responder station 715 of FIG. 7, as the responder station participates in setting up a TDLS direct link and receives a transmission over the TDLS direct link.

Operations 1000 may begin with the responder station receiving a TDLS Setup Request message with an information element including a group identifier and position (block 1005). The TDLS Setup Request message may have been sent by an initiator station by way of an AP. The responder station may perform a check to determine if the group identifier and the position are acceptable (block 1010). As an example, the group identifier and the position may be acceptable if there is not already a configured TDLS direct link with the responder station that uses the same group identifier and position. If the group identifier and the position are acceptable, the responder station may send a TDLS Setup Response message to the initiator station with an information element with the group identifier and the position (block 1015). The responder station may then receive a transmission from the initiator station that is labeled with the group identifier and located according to the position (block 1025).

If the group identifier and the position are not acceptable, then the responder station may select an alternate group identifier and/or an alternate position (block 1020). As an example, the responder station may randomly select the alternate group identifier and/or the alternate position. As another example, the responder station may maintain the group identifier and select a different position as the alternate position. The responder station may send a TDLS Setup Response message to the initiator station with an information element with the alternate group identifier and/or the alternate position (block 1015).

It is noted that beamforming is supported in TDLS direct links. Beamforming of individual independent spatial streams may be applied after VHT beamforming is performed. The beamforming of the individual independent spatial streams may make use of null data packet announcement (NDPA) frames as well as sounding poll control frames, for example.

FIG. 10b illustrates a second flow diagram of operations 1050 occurring in a responder station as the responder station participates in setting up a TDLS direct link and receives a transmission from an initiator station over the TDLS direct link. Operations 1050 may be indicative of operations occurring in a responder station, such as first responder station 710 and second responder station 715 of FIG. 7, as the responder station participates in setting up a TDLS direct link and receives a transmission over the TDLS direct link.

Operations 1050 may begin with the responder station receiving a TDLS Setup Request message (block 1055). The TDLS Setup Request message may have been sent by an initiator station by way of an AP. The responder station may receive a message that includes a group identifier and a position (block 1060). The message may be in the form of a frame, such as a Group Identifier Management frame. The TDLS Setup Request message and the frame may be received in separate transmissions or they may be piggybacked together or they may be separately or together piggybacked with other transmission(s).

The responder station may perform a check to determine if the group identifier and the position are acceptable (block 1065). As an example, the group identifier and the position may be acceptable if there is not already a configured TDLS direct link with the responder station that uses the same group identifier and position. If the group identifier and the position are acceptable, the responder station may send a TDLS Response message to the initiator station with a positive or affirmative response, or the TDLS Response message may include the group identifier and the position (block 1070). The responder station may then receive a transmission from the initiator station that is labeled with the group identifier and located according to the position (block 1075).

If the group identifier and the position are not acceptable, then the responder station may send a TDLS Response message to the initiator station with a negative response, or the TDLS Response message may include a suggested group identifier and position (block 1080). As an example, the responder station may randomly select the alternate group identifier and/or the alternate position. As another example, the responder station may maintain the group identifier and select a different position as the alternate position. The responder station may receive another message, e.g., a frame, which includes a different group identifier and/or position (block 1060). The responder station may perform a check to determine if the group identifier and the position are acceptable (block 1065). The responder station may continue checking the group identifier and the position until it finds one that is acceptable or until the initiator station stops sending messages including group identifiers and positions.

It is noted that beamforming is supported in TDLS direct links. Beamforming of individual independent spatial streams may be applied after VHT beamforming is performed. The beamforming of the individual independent spatial streams may make use of null data packet announcement (NDPA) frames as well as sounding poll control frames, for example.

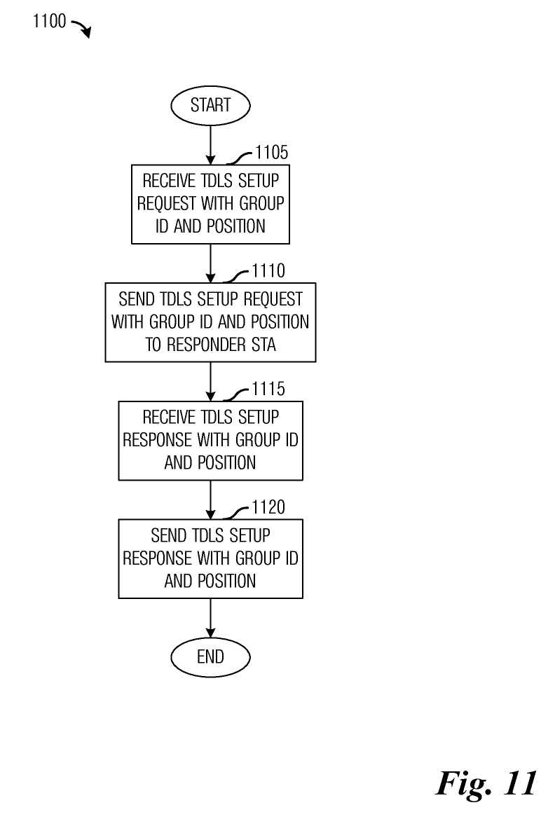

FIG. 11 illustrates a flow diagram of operations 1100 occurring in an AP as the AP receives and transmits transmissions in establishing a TDLS direct link. Operations 1100 may be indicative of operations occurring in an AP as the AP receives and transmits transmissions used in establishing a TDLS direct link.

Operations 1100 may begin with the AP receiving a TDLS Setup Request message with an information element including a group identifier and a position from an initiator station (block 1105). The AP may forward the TDLS Setup Request message to a responder station (block 1110). The AP may receive a TDLS Setup Response message with an information element including a response group identifier and a response position from the responder station (block 1115). The AP may forward the TDLS Setup Response message to the initiator station.

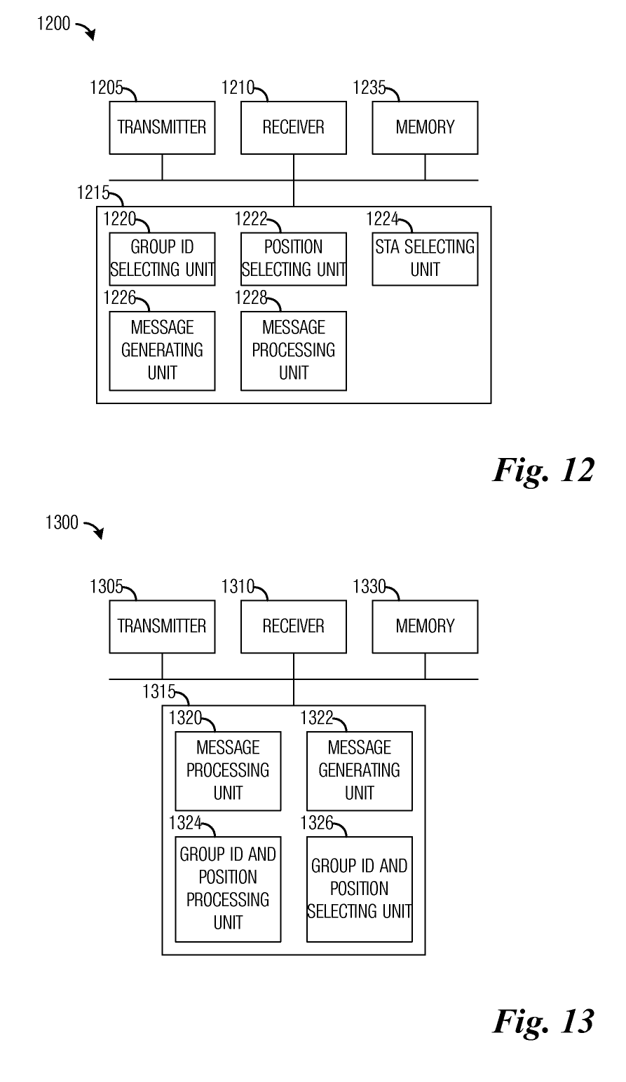

FIG. 12 illustrates a diagram of a first communications device 1200. First communications device 1200 may be an implementation of a station, such as an initiator station, of a communications system. First communications device 1200 may be used to implement various ones of the embodiments discussed herein. As shown in FIG. 12, a transmitter 1205 is configured to send TDLS Setup Request messages, information to an AP, information to a responder station over a TDLS direct link, and the like, and a receiver 1210 is configured to receive TDLS Setup Response messages, information, and the like. Transmitter 1205 and receiver 1210 may have a wireless interface, a wireline interface, or a combination thereof.

A group identifier selecting unit 1220 is configured to select a group identifier for a responder station. A position selecting unit 1222 is configured to select a position for a responder station in a group. Group identifier selecting unit 1220 and/or position selecting unit 1222 are configured to select the group identifier and/or the position according to a selection criteria such as available group identifiers, available positions, previously selected group identifiers, previously selected positions, conflicting group identifiers, conflicting positions, and the like. A station selecting unit 1224 is configured to select a responder station from a plurality of responder stations for TDLS direct link configuration.

A message generating unit 1226 is configured to generate messages, such as a TDLS Setup Request message to be transmitted to a responder station, the message includes an information element with a group identifier and a position for the responder station. Alternatively, message generating unit 1226 separately generates a TDLS Setup Request message and a message including a TDLS Group ID Management frame that contains a group identifier and a position for the responder station. A message processing unit 1228 is configured to process messages, such as a TDLS Setup Response message and/or a response message. A memory 1230 is configured to store group identifiers, positions, responder stations, TDLS direct link configurations, and the like.

The elements of first communications device 1200 may be implemented as specific hardware logic blocks. In an alternative, the elements of first communications device 1200 may be implemented as software executing in a processor, controller, application specific integrated circuit, or so on. In yet another alternative, the elements of first communications device 1200 may be implemented as a combination of software and/or hardware.

As an example, transmitter 1205 and receiver 1210 may be implemented as a specific hardware block, while group identifier selecting unit 1220, position selecting unit 1222, station selecting unit 1224, message generating unit 1226, and message processing unit 1228 may be software modules executing in a processor 1215, such as a microprocessor, a digital signal processor, a custom circuit, or a custom compiled logic array of a field programmable logic array.

FIG. 13 illustrates a diagram of a second communications device 1300. Second communications device 1300 may be an implementation of a station, such as a responder station, of a communications system. Second communications device 1300 may be used to implement various ones of the embodiments discussed herein. As shown in FIG. 13, a transmitter 1305 is configured to send TDLS Setup Response messages, information to an AP, and the like, and a receiver 1310 is configured to receive TDLS Setup Request messages, information from an initiator station over a TDLS direct link, and the like. Transmitter 1305 and receiver 1310 may have a wireless interface, a wireline interface, or a combination thereof.

A message processing unit 1320 is configured to process messages, such as a TDLS Setup Request message and/or a message including a TDLS Group ID Management frame. A message generating unit 1322 is configured to generate messages, such as a TDLS Setup Response message and/or a response message. A group identifier and position processing unit 1324 is configured to determine if a group identifier and/or a position provided in an information element of a TDLS Setup Request message or a TDLS Group ID Management frame conflict with existing group identifier and/or position configurations. A group identifier and position selecting unit 1326 is configured to select a group position and/or a position if a group identifier and/or a position provided in an information element of a TDLS Setup Request message or a TDLS Group ID Management frame conflict with existing group identifier and/or position configurations. A memory 1330 is configured to store group identifiers, positions, initiator stations, and the like.

The elements of second communications device 1300 may be implemented as specific hardware logic blocks. In an alternative, the elements of second communications device 1300 may be implemented as software executing in a processor, controller, application specific integrated circuit, or so on. In yet another alternative, the elements of second communications device 1300 may be implemented as a combination of software and/or hardware.

As an example, transmitter 1305 and receiver 1310 may be implemented as a specific hardware block, while message processing unit 1320, message generating unit 1322, group identifier and position processing unit 1324, and group identifier and position selecting unit 1326 may be software modules executing in a processor 1315, such as a microprocessor, a digital signal processor, a custom circuit, or a custom compiled logic array of a field programmable logic array.

Although the present disclosure and its advantages have been described in detail, it should be understood that various changes, substitutions and alterations can be made herein without departing from the spirit and scope of the disclosure as defined by the appended claims.

What is claimed is:

1. A method for transmitting to a plurality of responder stations, the method comprising:
configuring, by an initiator station, a first responder station for direct link communications, the first responder station being configured with a first group identifier and a first position;
configuring, by the initiator station, a second responder station for direct link communications, the second responder station being configured with a second group identifier and a second position; and
transmitting, by the initiator station, to both the first responder station and the second responder station in a first single transmission, the first single transmission includes first information for the first responder station and second information for the second responder station, wherein the first information is labeled with the first group identifier and located in the first position, and the second information is labeled with the second group identifier and located in the second position.

2. The method of claim 1, wherein configuring the first responder station comprises:
selecting the first group identifier and the first position for the first responder station;
transmitting a first setup request message including the first group identifier and the first position to the first responder station; and
receiving a first setup response message from the first responder station.

3. The method of claim 2, wherein configuring the second responder station comprises:
selecting the second group identifier and the second position for the second responder station;
transmitting a second setup request message including the second group identifier and the second position to the second responder station; and
receiving a second setup response message from the second responder station.

4. The method of claim 3, wherein the first setup request message and the second setup request message are tunnel direct link setup protocol messages.

5. The method of claim 2, wherein the first setup response message comprises the first group identifier and the first position in an information element.

6. The method of claim 2, wherein the first setup response message comprises a first alternate group identifier and a first alternate position, and wherein the method further comprises prior to transmitting to both the first responder station and the second responder station:
replacing the first group identifier with the first alternate group identifier; and
replacing the first position with the first alternate position.

7. The method of claim 2, wherein the first setup response message comprises a first alternate group identifier and a first alternate position, and wherein the method further comprises prior to transmitting to both the first responder station and the second responder station:
selecting a third group identifier and a third position for the first responder station;
configuring the first responder station for direct link communications using a third setup request message including the third group identifier and the third position;
replacing the first group identifier with the third group identifier; and
replacing the first position with the third position.

8. The method of claim 7, wherein the first group identifier and the third group identifier are equal.

9. The method of claim 2, further comprising transmitting the first setup request message to an access point serving the first responder station.

10. The method of claim 1, wherein the first single transmission is transmitted directly to the first responder station and the second responder station.

11. The method of claim 1, wherein the first single transmission includes a type of transmission indicator set to a first value, and wherein the type of transmission indicator is a physical layer indicator.

12. The method of claim 1, wherein the first single transmission includes a first indicator set to a second value and a second indicator set to a third value, and wherein the first indicator and the second indicator are media access control layer indicators.

13. The method of claim 1, wherein the initiator station, the first responder station, and the second responder station are devices in an IEEE 802.11 compliant communications system.

14. The method of claim 1, wherein configuring the first responder station comprises:
transmitting a first setup request message to the first responder station to configure a direct link communications channel;
selecting the first group identifier and the first position for the first responder station;
transmitting a first management message including the first group identifier and the first position to the first responder station; and
receiving a first management response message from the first responder station.

15. The method of claim 14, wherein the first setup message and the first management message are transmitted separately.

16. The method of claim 14, wherein the first setup message and the first management message are piggybacked in a second single transmission.

17. A method for receiving a first single transmission, the method comprising:
receiving, by a first responder station, a setup request message including a first group identifier and a first position;
transmitting, by the first responder station, a first setup response message including the first group identifier and the first position if the first group identifier and the first position are not already reserved for use by the first responder station; and
receiving, by the first responder station, the first single transmission including first information for the first responder station and second information for a second responder station, the first information labeled with the first group identifier and located in the first position.

18. The method of claim 17, further comprising transmitting a second setup response message including at least one of an alternate group identifier and an alternate position if the first group identifier and the first position are already reserved for use by the first responder station.

19. The method of claim 18, wherein the at least one of the alternate group identifier and the alternate position are selected in accordance with a selection criteria.

20. The method of claim 18, further comprising receiving a second single transmission including the first information for the first responder station and the second information for the second responder station, the first information labeled with the first group identifier and located in the alternate position.

21. The method of claim 18, further comprising receiving a third single transmission including the first information for the first responder station and the second information for the second responder station, the first information labeled with the alternate group identifier and located in the alternate position.

22. The method of claim 18, further comprising receiving a fourth single transmission including the first information for the first responder station and the second information for the second responder station, the first information labeled with the alternate group identifier and located in the first position.

23. A method for receiving a first single transmission, the method comprising:
receiving, by a first responder station, a setup request message to configure a direct link communications channel with an initiator station;
receiving, by the first responder station, a first management message including a first group identifier and a first position;
transmitting, by the first responder station, a first management response message including a positive response if the first group identifier and the first position are not already reserved for use by the first responder station; and
receiving, by the first responder station, the first single transmission including first information for the first responder station and second information for a second responder station, the first information labeled with the first group identifier and located in the first position.

24. The method of claim 23, further comprising transmitting a second management response message including a negative response if at least one of the first group identifier and the first position is already reserved for use by the first responder station.

25. The method of claim 24, further comprising:
receiving a second management message including a second group identifier and a second position; and
transmitting a second management response message including a positive response if the second group identifier and the second position are not already reserved for use by the first responder station.

26. The method of claim 23, wherein the setup request message and the first management message are received in separate transmissions.

27. The method of claim 23, wherein the setup request message and the first management message are received piggyback in a second single transmission.

28. An initiator station comprising:
a processor configured to setup a first responder station for direct link communications, the first responder station set up with a first group identifier and a first position, and to setup a second responder station for direct link communications, the second responder station set up with a second group identifier and a second position; and
a transmitter operatively coupled to the processor, the transmitter configured to transmit to both the first responder station and the second responder station in a first single transmission, the first single transmission includes first information for the first responder station and second information for the second responder station, the first information labeled with the first group identifier and located in the first position, and the second information labeled with the second group identifier and located in the second position.

29. The initiator station of claim 28, wherein the processor is configured to select the first group identifier and the first position for the first responder station, wherein the transmitter is configured to transmit a first setup request message including the first group identifier and the first position to the first responder station, and wherein the initiator station further comprises a receiver operatively coupled to the processor, the receiver configured to receive a first setup response message from the first responder station.

30. The initiator station of claim 29, wherein the processor is configured to select the second group identifier and the second position for the second responder station, wherein the transmitter is configured to transmit a second setup request message including the second group identifier and the second position to the second responder station, and wherein the receiver is configured to receive a second setup response message from the second responder station.

31. The initiator station of claim 29, wherein first setup response message comprises a first alternate group identifier and a first alternate position, and wherein the processor is configured to replace the first group identifier with the first alternate group identifier, and to replace the first position with the first alternate position.

32. The initiator station of claim 29, wherein the first setup response message comprises a first alternate group identifier and a first alternate position, and wherein the processor is configured to select a third group identifier and a third position for the first responder station, to configure the first responder station for direct link communications using a third setup request message including the third group identifier and the third position, to replace the first group identifier with the third group identifier, and to replace the first position with the third position.

33. The initiator station of claim 29, wherein the transmitter is configured to transmit the first setup request message to an access point serving the first responder station.

34. The initiator station of claim 28, wherein the first single transmission includes a type of transmission indicator set to a first value, and wherein the type of transmission indicator is a physical layer indicator.

35. The initiator station of claim 28, wherein the first single transmission includes a first indicator set to a second value and a second indicator set to a third value, and wherein the first indicator and the second indicator are media access control layer indicators.

36. The initiator station of claim 28, wherein the transmitter is configured to transmit a first setup request message to the first responder station to set up a direct link communications channel, and to transmit a first management message including the first group identifier and the first position of the first responder station, wherein the processor is configured to select the first group identifier and the first position for the first responder station, and wherein the initiator station further comprises a receiver operatively coupled to the processor, the receiver configured to receive a first management response message from the first responder station.

37. The initiator station of claim 36, wherein transmitter is configured to transmit the first setup message and the first management message in separate transmissions.

38. The initiator station of claim 36, wherein transmitter is configured to transmit the first setup message and the first management message in a second single transmission.

39. A first responder station comprising:
a receiver configured to receive a setup request message including a first group identifier and a first position, and to receive a first single transmission including first information for the first responder station and second information for a second responder station, the first information labeled with the first group identifier and located in the first position;
a transmitter configured to transmit a first setup response message including the first group identifier and the first position if the first group identifier and the first position are not already reserved for use by the first responder station; and
a processor operatively coupled to the receiver and to the transmitter, the processor configured to determine if the first group identifier and the first position are not already reserved for use by the first responder station.

40. The first responder station of claim 39, wherein the transmitter is configured to transmit a second setup response message including at least one of an alternate group identifier and an alternate position if the first group identifier and the first position are already reserved for use by the first responder station.

41. The first responder station of claim 40, wherein the receiver is configured to receive the transmission including the first information for the first responder station and the second information for the second responder station, the first information labeled with the first group identifier and located in the alternate position.

42. The first responder station of claim 40, wherein the receiver is configured to receive the transmission including the first information for the first responder station and the second information for the second responder station, the first information labeled with the alternate group identifier and located in the alternate position.

43. The first responder station of claim 40, wherein the receiver is configured to receive the transmission including the first information for the first responder station and the second information for the second responder station, the first information labeled with the alternate group identifier and located in the first position.

44. A first responder station comprising:
a receiver configured to receive a setup request message to configure a direct link communications channel with an initiator station, to receive a first management message including a first group identifier and a first position, and to receive a first single transmission including first information for the first responder station and second information for a second responder station, the first information labeled with the first group identifier and located in the first position;
a transmitter configured to transmit a first management response message including a positive response if the first group identifier and the first position are not already reserved for use by the first responder station; and
a processor operatively coupled to the receiver and to the transmitter, the processor configured to determine if the first group identifier and the first position are not already reserved for use by the first responder station.

45. The first responder station of claim 44, wherein the transmitter is configured to transmit a second management response message including a negative response if at least one of the first group identifier and the first position is already reserved for use by the first responder station.

46. The first responder station of claim 45, wherein the receiver is configured to receive a second management message including a second group identifier and a second position, and wherein the transmitter is configured to transmit a second management response message including a positive response if the second group identifier and the second position are not already reserved for use by the first responder station.
